(19) United States
(12) Patent Application Publication
(10) Pub. No.: US 2010/0119855 A1
(43) Pub. Date: May 13, 2010

(54) Thermoplastic Elastomer with Excellent Adhesion to EPDM Thermoset Rubber and Low Coefficient of Friction

(76) Inventors: Trazollah Ouhadi, Liege (BE); Randal Howard Kerstetter, III, Wadsworth, OH (US)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 12/579,963

(22) Filed: Oct. 15, 2009

Related U.S. Application Data
(60) Provisional application No. 61/112,969, filed on Nov. 10, 2008.

(51) Int. Cl. B32B 27/08; B29C 45/16

(52) U.S. Cl. 428/515; 264/241

(57) ABSTRACT

A thermoplastic elastomer with a low coefficient of friction and a composite structure made therefrom. The composite structure can include a first piece comprising a thermoplastic vulcanizate component and a second piece at least partially adhered to the first piece. The thermoplastic vulcanizate component includes an at least partially crosslinked rubber, a COF modifier, and a propylene-based copolymer that has (i) 60 wt % or more units derived from propylene, (ii) isotactically arranged propylene derived sequences and (iii) a heat of fusion less than 45 J/g. The second piece includes an EPDM thermoset based component that comprises one or more thermoset ethylene copolymer rubbers.

### CROSS-REFERENCE TO RELATED APPLICATIONS

This application claims priority from U.S. Provisional Application Ser. No. 61/112,969, filed Nov. 10, 2008, the contents of which are incorporated herein by reference in its entirety.

### BACKGROUND OF THE INVENTION

1. Field of the Invention

Embodiments described generally relate to composite structures comprising thermoplastic elastomers and articles made therefrom.

2. Description of the Related Art

Thermoplastic vulcanizates (TPVs) may be characterized by finely divided rubber particles dispersed within a plastic matrix. These rubber particles are crosslinked to promote elasticity. As such, TPVs exhibit the processing properties of the plastic and the elasticity of the rubber.

TPVs are conventionally produced by dynamic vulcanization. Dynamic vulcanization is a process whereby a rubber component is crosslinked or vulcanized within a blend of at least one non-vulcanizing polymer component while undergoing mixing or masticating at some elevated temperature. Usually, the temperature of this curing step is greater than the melt temperature of the non-vulcanizing polymer component.

TPVs have been used to form composite structures for use in automotive, industrial, and consumer markets. Some of those uses require the adhesion of a TPV component to other materials, such as thermoset rubber, to form a completed structure. Adhesion between the two components is difficult to obtain and difficult to maintain depending on, among other things, the adhering conditions, and the environment or conditions of use.

The adhesion to EPDM thermoset rubber has been improved by adding a plastomer or random copolymers to the TPV composition. For example, U.S. Pat. No. 7,008,699 discloses a two component composite structure where one of the polymer structures is made of EPDM blended with an effective amount of semicrystalline random adhesive copolymer, and the other polymer structure is made of a blend of dynamically vulcanized EPDM dispersed in a matrix of a thermoplastic polyolefin polymer. U.S. Pat. No. No. 7,008,699 also discloses that the second polymer structure may be blended with the semicrystalline random adhesive copolymer.

EP 0 601 790 discloses a two-layer sheet where each layer is made from an alpha olefin copolymer rubber and a polyolefin resin. The first layer or “skin layer” is partially crosslinked, and the second layer or “back surface layer” is non-crosslinked. EP 0 601 790 also discloses that the polyolefin resin is a homopolymer of ethylene or propylene, or copolymers of ethylene or propylene with small amounts of other polymeric monomers.

U.S. Pat. No. 7,326,471 discloses an automotive sealant composite structure made of a first piece comprising a first elastomeric component that includes an at least partially crosslinked rubber, a first olefinic thermoplastic resin component, and a second olefinic thermoplastic resin component. The second olefinic thermoplastic resin component includes a propylene copolymer that has (i) 60 wt % or more units derived from propylene, (ii) isotactically arranged propylene derived sequences and (iii) a heat of fusion less than 45 J/g. The composite structure also includes a second piece at least partially adhered to the first piece. The second piece can include one or more thermoset ethylene copolymer rubbers.

However, none of these references have been able to achieve high level of adhesion between a thermoplastic elastomer and a thermoset rubber and a low coefficient of friction. There is still a need, therefore, for a thermoplastic elastomer having a high level of adhesion with a thermoset rubber and a low coefficient of friction.

### SUMMARY

A thermoplastic elastomer with surprising adhesion to thermoset rubber is provided. The thermoplastic elastomer also has a surprisingly low coefficient of friction (COF).

In at least one specific embodiment, the thermoplastic elastomer composition includes an at least partially crosslinked rubber, a COF modifier, and a propylene-based copolymer that has (i) 60 wt % or more units derived from propylene, (ii) isotactically arranged propylene derived sequences and (iii) a heat of fusion less than 45 J/g.

A composite structure comprising the thermoplastic elastomer is also provided. In at least one specific embodiment, the composite structure can include a first piece comprising a thermoplastic vulcanizate component and a second piece at least partially adhered to the first piece. The thermoplastic vulcanizate component includes an at least partially crosslinked rubber, a COF modifier, and a propylene-based copolymer that has (i) 60 wt % or more units derived from propylene, (ii) isotactically arranged propylene derived sequences and (iii) a heat of fusion less than 45 J/g. The second piece includes an EPDM thermoset based component that comprises one or more thermoset ethylene copolymer rubbers.

### BRIEF DESCRIPTION OF THE DRAWINGS

FIG. 1 is an illustrative schematic of an “U shape” pre-cut sample used to measure adhesion, according to one or more embodiments described.

### DETAILED DESCRIPTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this patent is combined with available information and technology.

In one or more embodiments, the thermoplastic elastomer can be or include a thermoplastic vulcanizate (TPV). The term “thermoplastic vulcanizate” or “TPV” is broadly defined as any material that includes a dispersed, at least partially vulcanized, rubber component; a thermoplastic resin component; and an additive oil. A suitable TPV material can further include other ingredients, other additives, or both.

The term “vulcanizate” means a composition that includes some component (e.g., rubber component) that has been vulcanized. The term “vulcanized” is defined herein in its broadest sense, as reflected in any issued patent, printed publication, or dictionary, and refers in general to the state of a composition after all or a portion of the composition (e.g., crosslinkable rubber) has been subjected to some degree or amount of vulcanization. Accordingly, the term encompasses both partial and total vulcanization. A preferred type of vulcanization is “dynamic vulcanization,” discussed below, which also produces a “vulcanizate.” Also, in at least one specific embodiment, the term vulcanized refers to more than insubstantial vulcanization, e.g., curing (crosslinking) that results in a measurable change in pertinent properties, e.g., a change in the melt flow rate (MFR) of the composition by 10% or more (according to any ASTM-1238 procedure). In at least that context, the term vulcanization encompasses any form of curing (crosslinking) both thermal and chemical that can be utilized in dynamic vulcanization.

The term “dynamic vulcanization” means vulcanization or curing of a curable rubber blended with a thermoplastic resin under conditions of shear at temperatures sufficient to plasticize the mixture. In at least one embodiment, the rubber is simultaneously crosslinked and dispersed as micro-sized particles within the thermoplastic resin component. Depending on the degree of cure, the rubber to thermoplastic resin component ratio, compatibility of the rubber and thermoplastic resin component, the kneader type and the intensity of mixing (shear rate), other morphologies, such as co-continuous rubber phases in the plastic matrix, are possible.

As the term is used herein, a “partially vulcanized” rubber is one wherein more than 5 weight percent (wt %) of the crosslinkable rubber is extractable in boiling xylene, subsequent to vulcanization (preferably dynamic vulcanization), e.g., crosslinking of the rubber phase of the thermoplastic vulcanizate. For example, at least 5 wt % and less than 20 wt % or 30 wt % or 50 wt % of the crosslinkable rubber may be extractable from the specimen of the thermoplastic vulcanizate in boiling xylene. The percentage of extractable rubber can be determined by the technique set forth in U.S. Pat. No. 4,311,628.

Preferably, the percent of soluble rubber in the cured composition is determined by refluxing a specimen in boiling xylene, weighing the dried residue and making suitable corrections for soluble and insoluble components based upon knowledge of the composition. Thus, corrected initial and final weights are obtained by subtracting from the initial weight the weight of the soluble components, other than the rubber to be vulcanized, such as extender oils, plasticizers and components of the compositions soluble in organic solvent, as well as that rubber component that it is not intended to cure. Any insoluble pigments, fillers, etc., are subtracted from both the initial and final weights. Any materials in the uncured rubber that are soluble in refluxing xylene are subtracted from the rubber when calculating the percent of soluble rubber in a cured composition, up to about 5 wt %, typically between about 0.5 wt % to about 2.0 wt %, of EPDM rubber is soluble in refluxing xylene.

A “fully vulcanized” (or fully cured or fully crosslinked) rubber is one wherein less than 5 wt % of the crosslinkable rubber is extractable in boiling xylene subsequent to vulcanization (preferably dynamic vulcanization), e.g., crosslinking of the rubber phase of the thermoplastic vulcanizate. Preferably, 4 wt % or less, or 3 wt % or less, or 2 wt % or less, or 1 wt % or less of the crosslinkable rubber is extractable in boiling xylene.

### Rubber Component

The rubber component can be or include one or more ethylene copolymer rubber. The “ethylene copolymer rubber” can be any ethylene-containing rubber such as ethylene-propylene copolymer rubber (EPR), ethylene-propylene-diene (EPDM) rubber, and EPDM-type rubbers, for example. An EPDM-type rubber can be a terpolymer derived from the polymerization of ethylene and at least one different monoolefin monomer having from 3 to 10 carbon atoms, preferably 3 to 4 carbon atoms, and at least one polyunsaturated olefin having from 5 to 20 carbon atoms. Those monoolefins desirably have the formula CH₂═CH—R where R is H or an alkyl of 1-12 carbon atoms and is preferably propylene. Desirably the repeat units from ethylene and the at least one monoolefin (and preferably from ethylene and propylene) are present in the polymer in weight ratios of 25:75 to 75:25 (ethylene:propylene) and constitute from about 90 wt % to about 99.6 wt % of the polymer.

The polyunsaturated olefin can be a straight chained, branched, cyclic, bridged ring, bicyclic, fused ring bicyclic compound etc., and preferably is a nonconjugated diene. Repeat units from the nonconjugated polyunsaturated olefin are preferably from about 0.4 wt % to about 10 wt % of the rubber. The polyunsaturated olefin may include, but are not limited to, 5-ethylidene-2-norbornene; 5-vinyl-2-norbornene; divinyl benzene; 1,4-hexadiene; 5-methylene-2-norbornene; 1,6-octadiene; 5-methyl-1,4-hexadiene; 3,7-dimethyl-1,6-octadiene; 1,3-cyclopentadiene; 1,4-cyclohexadiene; dicyclopentadiene; or combinations thereof.

### Thermoplastic Resin Component

The thermoplastic resin component can be or include one or more olefinic thermoplastic resins. The “olefinic thermoplastic resin” may be any material that is not a “rubber” and that is a polymer or polymer blend considered by persons skilled in the art as being thermoplastic in nature, e.g., a polymer that softens when exposed to heat and returns to its original condition when cooled to room temperature. The olefinic thermoplastic resin component may contain one or more polyolefins, including polyolefin homopolymers and polyolefin copolymers. Except as stated otherwise, the term “copolymer” means a polymer derived from two or more monomers (including terpolymers, tetrapolymers, etc.), and the term “polymer” refers to any carbon-containing compound having repeat units from one or more different monomers.

Illustrative polyolefins may be prepared from mono-olefin monomers including, but are not limited to, monomers having 2 to 7 carbon atoms, such as ethylene, propylene, 1-butene, isobutylene, 1-pentene, 1-hexene, 1-octene, 3-methyl-1-pentene, 4-methyl-1-pentene, 5-methyl-1-hexene, mixtures thereof and copolymers thereof with (meth)acrylates and/or vinyl acetates. Preferably, the olefinic thermoplastic resin component is unvulcanized or non cross-linked.

In one or more embodiments, the olefinic thermoplastic resin component is or includes polypropylene. The term “polypropylene” as used herein broadly means any polymer that is considered a “polypropylene” by persons skilled in the art (as reflected in at least one patent or publication), and includes homo, impact, and random polymers of propylene. Preferably, the polypropylene used in the compositions described herein has a melting point above 110° C., includes at least 90 wt % propylene units, and contains isotactic sequences of those units. The polypropylene may also include atactic sequences or syndiotactic sequences, or both. The polypropylene can either derive exclusively from propylene monomers (i.e., having only propylene units) or derive from mainly propylene (more than 80% propylene) with the remainder derived from olefins, particularly ethylene, and/or C₄-C₁₀ alpha-olefins. As noted elsewhere herein, certain polypropylenes have a high MFR ranging from a low of about 10, or 15, or 20 g/10 min to a high of about 25 to 2,000 g/10 min, as measured according to ASTM D-1238 at 230° C. under 2.16 kg loading. Others have a lower MFR, e.g., “fractional” polypropylenes which have an MFR less than 1.0 g/10 min. Those with high MFR may be preferred for ease of processing or compounding.

In one or more embodiments, the olefinic thermoplastic resin component is or includes isotactic polypropylene. Preferably, the olefinic thermoplastic resin component is or includes one or more crystalline propylene homopolymers or copolymers of propylene having a melting temperature of from 110° C. to 170° C. or higher as measured by Differential Scanning Calorimetry (DSC). Preferred copolymers of propylene include, but are not limited to, terpolymers of propylene, impact copolymers of propylene, random polypropylene and mixtures thereof. Preferred comonomers have 2 carbon atoms, or from 4 to 12 carbon atoms. Preferably, the comonomer is ethylene. Such olefinic thermoplastic resin components and methods for making the same are described in U.S. Pat. No. 6,342,565.

The term “random polypropylene” as used herein broadly means a single phase copolymer of propylene having up to 9 wt %, preferably 2 wt % to 8 wt % of an alpha olefin comonomer. Preferred alpha olefin comonomers have 2 carbon atoms, or from 4 to 12 carbon atoms. Preferably, the alpha olefin comonomer is ethylene.

In one or more embodiments, the olefinic thermoplastic resin component is or includes a “propylene-based copolymer.” A “propylene-based copolymer” includes at least two different types of monomer units, one of which is propylene. Suitable monomer units include, but are not limited to, ethylene and higher alpha-olefins ranging from C₄ to C₂₀, such as, for example, 1-butene, 4-methyl-1-pentene, 1-hexene or 1-octene and 1-decene, or mixtures thereof, for example. Preferably, ethylene is copolymerized with propylene, so that the propylene-based copolymer includes propylene-derived units (units on the polymer chain derived from propylene monomers) and ethylene-derived units (units on the polymer chain derived from ethylene monomers).

In one or more embodiments, the propylene-based copolymer is made using random polymerization methods, including those described in U.S. Pat. Nos. 6,288,171; 6,525,157; 5,712,352; 5,693,727; 5,677,375; 5,668,228; 5,665,818; 5,627,242; 5,616,661; 5,462,999; 5,453,471; 5,436,304; 5,405,922; 5,352,749; 5,317,036; 5,028,670; 5,001,205; 4,613,484; 4,588,790; 4,543,399; 3,248,179; as well as 5,696,213; 5,625,016; EP 0 794 200; EP 0 802 202; and EP 0 634 421. However, the propylene-based copolymer is not limited by any particular polymerization method. Suitable polymerization methods include gas phase, slurry, and solution, for example.

Preferred methods and catalysts for producing the propylene-based copolymers are found in publications U.S. Pat. Nos. 7,232,871 and 6,881,800, and WO 2005/049672. Pyridine amine complexes, such as those described in U.S. Pat. No. 6,960,635 are also useful to produce the propylene-based copolymers useful herein. The catalyst can involve a fluxional complex, which undergoes periodic intra-molecular re-arrangement so as to provide the desired interruption of stereoregularity as in U.S. Pat. No. 6,559,262. The catalyst can be a stereorigid complex with mixed influence on propylene insertion, see Rieger EP 1 070 087. The catalyst described in EP 1 614 699 could also be used for the production of backbones suitable for the propylene-based copolymer.

The propylene-based copolymer can have an average propylene content of 60 wt % or more, based on the weight of the copolymer. The propylene-based copolymer can have an average propylene content of from about 60 wt % to about 93 wt %, more preferably from about 60 wt % to about 90 wt %, more preferably from about 60 wt % to about 87 wt %, more preferably from about 60 wt % to about 82 wt %, more preferably from about 60 wt % to about 75 wt % based on the weight of the copolymer. Other preferred ranges are from about 70 wt % to about 91 wt % propylene-derived units, more preferably from about 75 wt % to about 90 wt % propylene-derived units, more preferably from about 80 wt % to about 89 wt % propylene-derived units, and more preferably from about 80 wt % to about 88 wt % propylene-derived units, and more preferably from about 80 wt % to about 87 wt % propylene based on the weight of the copolymer. In one embodiment, the balance comprises units derived from one or more α-olefins. The one or more α-olefins may comprise ethylene, or one or more C₄-C₂₀ α-olefin or a combination of ethylene and one or more C₄-C₂₀ α-olefin. In another embodiment, the one or more α-olefins may comprise ethylene, or one or more C₄-C₁₂ α-olefins or a combination of ethylene and one or more C₄-C₁₂ α-olefins.

In a preferred embodiment, the one or more α-olefins is or includes ethylene. The ethylene content can be greater than 8 wt % and up to about 30 wt % based on total weight of the propylene-based copolymer. The ethylene content can be of from about 10 wt % to about 15 wt % based on total weight of the propylene-based copolymer. In one or more embodiments, the ethylene content can range from a low of about 8 wt %, 10 wt %, or 12 wt % to a high of about 15 wt %, 20 wt % or 30 wt %.

In another embodiment, the one or more α-olefins is or includes butene. The butene content can be greater than 8 wt % and up to about 30 wt % based on total weight of the propylene-based copolymer. The butene content can be of from about 10 wt % to about 15 wt % based on total weight of the propylene-based copolymer. In one or more embodiments, the butene content can range from a low of about 8 wt %, 10 wt %, or 12 wt % to a high of about 15 wt %, 20 wt % or 30 wt %.

The propylene-based copolymer can have a weight average molecular weight (Mw) of 5,000,000 or less, a number average molecular weight (Mn) of about 3,000,000 or less, a z-average molecular weight (Mz) of about 10,000,000 or less, and a g′ index of 0.95 or greater measured at the weight average molecular weight (Mw) of the polymer using isotactic polypropylene as the baseline, all of which can be determined by size exclusion chromatography, e.g., 3D SEC, also referred to as GPC-3D as described herein.

In one or more embodiments above or elsewhere herein, the propylene-based copolymer can have a Mw of about 5,000 to about 5,000,000 g/mole, more preferably a Mw of about 10,000 to about 1,000,000, more preferably a Mw of about 20,000 to about 500,000, more preferably a Mw of about 50,000 to about 400,000, more preferably a Mw of about 60,000 to about 300,000, more preferably a Mw of about 70,000 to about 250,000, wherein Mw is determined as described herein. In one or more embodiments, the propylene-based copolymer can have a Mw ranging from a low of about 70,000, about 80,000, about 90,000, about 100,000, or about 120,000 to a high of about 160,000, about 180,000, about 200,000, about 220,000, or about 250,000.

In one or more embodiments above or elsewhere herein, the propylene-based copolymer can have a Mn of about 2,500 to about 2,500,000 g/mole, more preferably a Mn of about 5,000 to about 500,000, more preferably a Mn of about 10,000 to about 250,000, more preferably a Mn of about 25,000 to about 200,000, wherein Mn is determined as described herein.

In one or more embodiments above or elsewhere herein, the propylene-based copolymer can have a Mz of about 10,000 to about 7,000,000 g/mole, more preferably a Mz of about 50,000 to about 1,000,000, more preferably a Mz of about 80,000 to about 700,000, more preferably a Mz of about 100,000 to about 500,000, wherein Mz is determined as described herein.

The molecular weight distribution index (MWD=(Mw/Mn)), sometimes referred to as a “polydispersity index” (PDI), of the propylene-based copolymer can be about 1.5 to 40. In an embodiment the MWD can have an upper limit of about 40, or 20, or 10, or 5, or 4.5, or 4, or 3, or 2.5, or 2.4, or 2.2 and a lower limit of about 1.3, or 1.5, or 1.7, or 1.8, or 2.0, or 2.1. In one or more embodiments above or elsewhere herein, the MWD of the propylene-based copolymer is about 1.8 to 5, more preferably 1.8 to 3, and most preferably about 2.1 to 2.4. Techniques for determining the molecular weight (Mn and Mw) and molecular weight distribution (MWD) can be found in U.S. Pat. No. 4,540,753, Macromolecules, 1988, volume 21, p 3360 (Verstrate et al.), and in accordance with the procedures disclosed in U.S. Pat. No. 6,525,157, particularly column 5, lines 1-44.

In one or more embodiments above or elsewhere herein, the propylene-based copolymer can have a g′ index value of 0.95 or greater, preferably at least 0.98, with at least 0.99 being more preferred, wherein g′ is measured at the Mw of the polymer using the intrinsic viscosity of isotactic polypropylene as the baseline. For use herein, the g′ index is defined as:

$${g}^{′} = \frac{{η}_{b}}{{η}_{l}}$$

where η_{b} is the intrinsic viscosity of the propylene-based copolymer and η₁ is the intrinsic viscosity of a linear polymer of the same viscosity-averaged molecular weight (Mᵥ) as the propylene-based copolymer. η₁=KMᵥ^{α}, K and α were measured values for linear polymers and should be obtained on the same instrument as the one used for the g′ index measurement.

In one or more embodiments above or elsewhere herein, the propylene-based copolymer can have a density of about 0.85 g/cm³ to about 0.92 g/cm³, more preferably, about 0.87 g/cm³ to 0.90 g/cm³, more preferably about 0.88 g/cm³ to about 0.89 g/cm³ at room temperature as measured per the ASTM D-1505 test method.

In one or more embodiments above or elsewhere herein, the propylene-based copolymer can have a MFR (ASTM D-1238 @ 2.16 kg weight and 230° C.), equal to or greater than 0.2 g/10 min as measured according to the ASTM D-1238 test method as modified (described below). Preferably, the MFR (ASTM D-1238 @ 2.16 kg weight and 230° C.) is from about 0.5 g/10 min to about 200 g/10 min and more preferably from about 1 g/10 min to about 100 g/10 min. In an embodiment, the propylene-based copolymer has an MFR upper limit of about 200 g/10 min, about 150 g/10 min, about 100 g/10 min, about 75 g/10 min, about 50 g/10 min, about 30 g/10 min, about 25 g/10 min, or about 20 g/10 min and a lower limit of about 0.1 g/10 min, about 0.5 g/10 min, about 1 g/10 min, about 2 g/10 min, about 3 g/10 min, about 4 g/10 min, about 5 g/10 min, about 8 g/10 min, or about 10 g/10 min. In another embodiment, the propylene-based copolymer has an MFR of 0.5 g/10 min to 200 g/10 min, preferably from 2 g/10 min to 30 g/10 min, more preferably from 3 g/10 min to 21 g/10 min, more preferably from 5 g/10 min to 30 g/10 min, more preferably 10 g/10 min to 30 g/10 min, more preferably 10 g/10 min to about 25 g/10 min, or more preferably 2 g/10 min to about 10 g/10 min.

The propylene-based copolymer can have a Mooney viscosity ML (1+4)@125° C., as determined according to ASTM D1646, of less than 100, more preferably less than 75, even more preferably less than 60, most preferably less than 30. In one or more embodiments above or elsewhere herein, the Mooney viscosity can range from a low of about 1, 5, 10, or to a high of about 30, 60, 75 or 100.

In one or more embodiments, the propylene-based copolymer has a Shore A hardness of less than about 90. In one or more embodiments, the propylene-based copolymer has a Shore A hardness of about 45 to about 90. In one or more embodiments, the propylene-based copolymer has a Shore A hardness of about 55 to about 80.

Due to the introduction of errors in the insertion of propylene and/or by the presence of comonomer, the crystallinity and the melting point of the propylene-based copolymer are reduced compared to highly isotactic polypropylene. For example, the propylene-derived crystallinity of the propylene-based copolymer may range from about 2% to about 65% in one embodiment and from about 5% to about 40% in another embodiment as measured by DSC.

In one or more embodiments above or elsewhere herein, the propylene-based copolymer can have a heat of fusion (Hf) determined according to the DSC procedure described later, which is greater than or equal to about 0.5 Joules per gram (J/g), and is <about 80 J/g, preferably <about 75 J/g, preferably <about 70 J/g, more preferably <about 60 J/g, more preferably <about 50 J/g, more preferably <about 45 J/g, more preferably <about 35 J/g. Also preferably, the propylene-based copolymer has a heat of fusion that is greater than or equal to about 1 J/g, preferably greater than or equal to about 5 J/g. In another embodiment, the propylene-based copolymer can have a heat of fusion (Hf), which is from about 0.5 J/g to about 75 J/g, preferably from about 1 J/g to about 75 J/g, more preferably from about 0.5 J/g to about 35 J/g. In one or more embodiments, the heat of fusion ranges from a lower limit of 1.0 J/g, or 1.5 J/g, or 3.0 J/g, or 4.0 J/g, or 6.0 J/g, or 7.0 J/g, to an upper limit of 30 J/g, or 35 J/g, or 40 J/g, 45 J/g, or 50 J/g, or 60 J/g or 70 J/g, or 75 J/g, or 80 J/g.

Preferred propylene-based copolymers and compositions can be characterized in terms of both their melting points (Tm) and heats of fusion, which properties can be influenced by the presence of comonomers or steric irregularities that hinder the formation of crystallites by the polymer chains. The crystallinity of the propylene-based copolymer can also be expressed in terms of percentage of crystallinity (i.e. % crystallinity). In certain embodiments above or elsewhere herein, the propylene-based copolymer is substantially amorphous characterized in that it has 0% crystallinity as determined according to the DSC procedure described below. In other embodiments above or elsewhere herein, the propylene-based copolymer has a percent (%) crystallinity of from 0.5% to 40%, preferably 1% to 30%, more preferably 5% to 25% wherein % crystallinity is determined according to the DSC procedure described below. In another embodiment, the propylene-based copolymer preferably has a crystallinity of less than 40%, preferably about 0.25% to about 25%, more preferably from about 0.5% to about 22%, and most preferably from about 0.5% to about 20%. As disclosed above, the thermal energy for the highest order of polypropylene is estimated at 189 J/g (i.e., 100% crystallinity is equal to 189 J/g.).

In addition to this level of crystallinity, the propylene-based copolymer preferably has a single broad melting transition. However, the propylene-based copolymer can show secondary melting peaks adjacent to the principal peak, but for purposes herein, such secondary melting peaks are considered together as a single melting point, with the highest of these peaks (relative to baseline as described herein) being considered the melting point of the propylene-based copolymer.

The propylene-based copolymer preferably has a melting point (measured by DSC) of equal to or less than 100° C., preferably less than 90° C., preferably less than 80° C., more preferably less than or equal to 75° C., preferably from about 25° C. to about 80° C., preferably about 25° C. to about 75° C., more preferably about 30° C. to about 65° C.

Heat of fusion, % crystallinity and melting temperature of the propylene-based copolymer can be determined, for example by a Differential Scanning Calorimetry (DSC) procedure using the following steps.

About 0.5 g is placed between two sheets of MYLAR film (E.I, Du Pont de Nemours and Company) (“mylar”). The mylar/polymer/mylar “sandwich” is then placed on top of a small cavity mold with no top cover sheet. The dimensions of the cavity mold are 1″×2″×˜0.020″. The mold and sample are then placed in a heated hydraulic press. The press temperature is usually set between 150° C. to 200° C. The platens of the press are closed and a force of about 15 tons is maintained for about 3-5 minutes. The platens are then opened while still at the above mentioned prescribed temperature and the mylar/polymer/mylar “sandwich” is removed from the mold. The sample, mylar/polymer/mylar “sandwich” is allowed to anneal for no less than 24 hours, and no greater than 48 hours by hanging in air at room temperature (actual time is to be noted). After the annealing period, the pressed pad is removed from the mylar and cut crosswise then folded over onto itself, forming a double layer. From this double layer a circular disk is cut out, using a leather punch or other paper punch device. Five samples will be prepared. The sample weights will be recorded, and should be no less than 8 mg and no greater than 12 mg. The samples are then placed in individual 10 micro-liter aluminum pans. Unvented aluminum lids will be crimped on top of each pan, insuring good contact between the samples and the pans. The sample pans are then placed in a calibrated DSC instrument with an empty pan with lid on the reference side and run using the following parameters, under N2 purge gas (˜20 ml/min). An empty pan will be run in addition to the five samples. Automatic subtraction of the empty pan run from the sample runs will be enabled. The DSC heat history will be as follows. Cool the sample from room temperature to −75° C. as quickly as the DSC is capable. Hold at −75° C. for three minutes. Ramp the temperature at a heating rate of 20° C. per minute to a temperature sufficiently high to completely melt the sample. The thermograms generated from this step are used to determine melting point, specific heat and degree of crystallinity. The output data from DSC consists of time (sec), temperature (° C.), and heat flow (watts). Each of the five sample melting thermograms will be analyzed as follows. First, the total heat flow is divided by the sample mass to obtain a specific heat flow (units: W/g). Second, a baseline is constructed and subtracted from the specific heat flow to give baseline-subtracted heat flow. For the analyses discussed here, a straight-line baseline will be used. The lower temperature baseline limit will be above the glass transition temperature, but below the temperature at which the sample begins to melt. The upper baseline temperature limit will be a temperature 5° C. to 10° C. above the completion of the melting endotherm. The following three parameters will then be determined separately for each of the five runs:

(1) Melting Point—The peak melting temperature is the temperature between the lower and upper baseline settings which has the greatest baseline-subtracted heat flow.

(2) The specific heat of melting, Δhm (J/g) is the area under the melting endotherm obtained by integrating the baseline-subtracted heat flow versus time between the baseline limits.

(3) The percent crystallinity is determined by dividing the specific heat of melting by 189 J/g and multiplying by 100.

The sample melting temperature, specific heat, and percent crystallinity will be the average over the five runs after excluding outliers. An outlier will be as defined by the method prescribed by Dixon (Biometrics, Vol. 9, #1 March, 1953, 74-89) using a 95% confidence level.

Preferably, the propylene-based copolymer has crystalline regions interrupted by non-crystalline regions. The non-crystalline regions may result from regions of non-crystallizable polypropylene segments, the inclusion of comonomer units, or both. In one or more embodiments, the propylene-based copolymer has a propylene-derived crystallinity that is isotactic, syndiotactic, or a combination thereof. In a preferred embodiment, the propylene-based copolymer has isotactic sequences. The presence of isotactic sequences can be determined by NMR measurements showing two or more propylene derived units arranged isotactically. Such isotactic sequences may, in some cases be interrupted by propylene units that are not isotactically arranged or by other monomers that otherwise disturb the crystallinity derived from the isotactic sequences.

In one or more embodiments, the propylene-derived units of the propylene-based copolymer have an isotactic triad fraction of about 65% to about 99%. In one or more embodiments, the propylene-derived units of the propylene-based copolymer have an isotactic triad fraction of about 70% to about 98%. In one or more embodiments, the propylene-derived units of the propylene-based copolymer have an isotactic triad fraction of about 75% to about 97%.

The triad tacticity of a polymer is the relative tacticity of a sequence of three adjacent propylene units, a chain consisting of head to tail bonds, expressed as a binary combination of m and r sequences. It is usually expressed for the propylene-based copolymers described as the ratio of the number of units of the specified tacticity to all of the propylene triads in the polymer.

In one or more embodiments above or elsewhere herein, the propylene-based copolymer can have a triad tacticity of about 80% or more, about 83% or more, about 85% or more, about 87% or more, about 90% or more, about 91% or more, about 92% or more, about 93% or more, about 94% or more, or about 95% or more. Preferably, the propylene-based copolymer has a triad tacticity that is greater than or equal to about 80%, preferably greater than or equal to about 85%, or preferably greater than or equal to about 90%. In another embodiment, the propylene-based copolymer can have a triad tacticity, which is about 88% or more, about 90% or more, or about 96% or more. In one or more embodiments, the triad tacticity of the propylene-based copolymer ranges from a lower limit of 80%, or 82%, or 84%, or 86%, to an upper limit of about 88%, 90% 92%, 93%, or 94%, or 95%, or 96%, or more.

The triad tacticity (mm fraction) of a propylene-based copolymer can be determined from a ¹³C NMR spectrum and the following formula:

$$mm Fraction = \frac{PPP ( mm )}{PPP ( mm ) + PPP ( mr ) + PPP ( rr )}$$

where PPP(mm), PPP(mr) and PPP(rr) denote peak areas derived from the methyl groups of the second units in the following three propylene unit chains consisting of head-to-tail bonds:

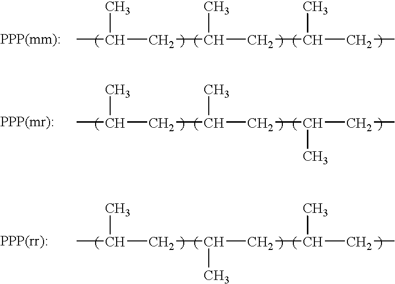

The ¹³C NMR spectrum relating to the methyl carbon region (19-23 parts per million (ppm)) can be divided into a first region (21.2-21.9 ppm), a second region (20.3-21.0 ppm) and a third region (19.5-20.3 ppm). Each peak in the spectrum can be assigned with reference to an article in the journal Polymer, Volume 30 (1989), page 1350. In the first region, the methyl group of the second unit in the three propylene unit chain represented by PPP (mm) resonates. In the second region, the methyl group of the second unit in the three propylene unit chain represented by PPP (mr) resonates, and the methyl group (PPE-methyl group) of a propylene unit whose adjacent units are a propylene unit and an ethylene unit resonates (in the vicinity of 20.7 ppm). In the third region, the methyl group of the second unit in the three propylene unit chain represented by PPP (rr) resonates, and the methyl group (EPE-methyl group) of a propylene unit whose adjacent units are ethylene units resonates (in the vicinity of 19.8 ppm). Additional details and information can be found in U.S. Pat. No. 5,504,172.

Examples of 2,1 insertion are shown in structures 1 and 2 below.

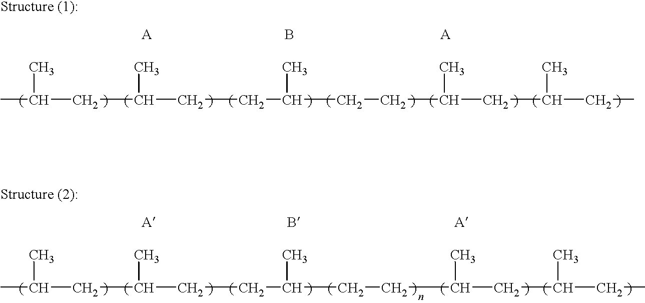

where n 2.

A peak of the carbon A and a peak of the carbon A′ appear in the second region. A peak of the carbon B and a peak of the carbon B′ appear in the third region, as described above. Among the peaks which appear in the first to third regions, peaks which are not based on the 3 propylene unit chain consisting of head-to-tail bonds are peaks based on the PPE-methyl group, the EPE-methyl group, the carbon A, the carbon A′, the carbon B, and the carbon B′.

The peak area based on the PPE-methyl group can be evaluated by the peak area of the PPE-methine group (resonance in the vicinity of 30.8 ppm), and the peak area based on the EPE-methyl group can be evaluated by the peak area of the EPE-methine group (resonance in the vicinity of 33.1 ppm). The peak area based on the carbon A can be evaluated by twice as much as the peak area of the methine carbon (resonance in the vicinity of 33.9 ppm) to which the methyl group of the carbon B is directly bonded; and the peak area based on the carbon A′ can be evaluated by the peak area of the adjacent methine carbon (resonance in the vicinity of 33.6 ppm) of the methyl group of the carbon B′. The peak area based on the carbon B can be evaluated by the peak area of the adjacent methine carbon (resonance in the vicinity of 33.9 ppm); and the peak area based on the carbon B′ can be also evaluated by the adjacent methine carbon (resonance in the vicinity of 33.6 ppm).

By subtracting these peak areas from the total peak areas of the second region and the third region, the peak areas based on the three propylene unit chains (PPP(mr) and PPP(rr)) consisting of head-to-tail bonds can be obtained. Thus, the peak areas of PPP(mm), PPP(mr) and PPP(rr) can be evaluated, and the triad tacticity of the propylene unit chain consisting of head-to-tail bonds can be determined.

Similarly, the peak areas based on the 3 propylene units-chains (PPP(mr) and PPP(rr)) consisting of head-to-tail bonds can be obtained by subtracting the peak areas for the error in propylene insertions (both 2,1 and 1,3) from peak areas from the total peak areas of the second region and the third region, Thus, the peak areas of PPP(mm), PPP(mr) and PPP(rr) can be evaluated, and hence the triad tacticity of the propylene unit chain consisting of head-to-tail bonds can be determined.

The proportion of the 2,1-insertions to all of the propylene insertions in a propylene elastomer can be calculated by the following formula as described in Polymer, vol. (1989), p. 1350.

Proportion of inversely inserted unit based on 2,1-insertion (%) is equal to:

$$\frac{0.25 I α β ( structure ( i ) ) + 0.51 I α β ( structure ( ii ) )}{I αα + I α β ( structure ( ii ) ) + 0.5 ( I α γ + I α β ( structure ( i ) ) + I α δ )} \times 100$$

Naming of the peaks in the above formula was made in accordance with a method by Carman, et al. in the journal Rubber Chemistry and Technology, volume 44 (1971), page 781, where Iαδ denotes a peak area of the αδ+ secondary carbon peak. It is difficult to separate the peak area of 14 (structure (i)) from Iαβ (structure (ii)) because of overlapping of the peaks. Carbon peaks having the corresponding areas can be substituted therefore.

The measurement of the 1,3 insertion requires the measurement of the βγ peak. Two structures can contribute to the βγ peak: (1) a 1,3 insertion of a propylene monomer; and (2) from a 2,1-insertion of a propylene monomer followed by two ethylene monomers. This peak is described as the 1.3 insertion peak and we use the procedure described in U.S. Pat. No. 5,504,172, which describes this βγ peak and understand it to represent a sequence of four methylene units. The proportion (%) of the amount of these errors was determined by dividing the area of the βγ peak (resonance in the vicinity of 27.4 ppm) by the sum of all the methyl group peaks and ½ of the area of the βγ peak, and then multiplying the resulting value by 100. If an α-olefin of three or more carbon atoms is polymerized using an olefin polymerization catalyst, a number of inversely inserted monomer units are present in the molecules of the resultant olefin polymer. In polyolefins prepared by polymerization of α-olefins of three or more carbon atoms in the presence of a chiral metallocene catalyst, 2,1-insertion or 1,3-insertion takes place in addition to the usual 1,2-insertion, such that inversely inserted units such as a 2,1-insertion or a 1,3-insertion are formed in the olefin polymer molecule (see, Macromolecular Chemistry Rapid Communication, Volume 8, page 305 (1987), by K. Soga, T. Shiono, S. Takemura and W. Kaminski).

Preferably, the proportion of inversely inserted propylene units of the propylene-based copolymer, based on the 2,1-insertion of a propylene monomer in all propylene insertions, as measured by ¹³C NMR, is greater than 0.5%, or greater than 0.6%. The proportion of inversely inserted propylene units of the propylene-based copolymer, based on the 1,3-insertion of a propylene monomer, as measured by ¹³C NMR, is greater than 0.05%, or greater than 0.06%, or greater than 0.07%, or greater than 0.08%, or greater than 0.085%.

Furthermore, the propylene-derived crystallinity of the propylene-based copolymer can be selected to ensure the desired compatibility with the other ingredients of the TPV composition, e.g., with the other polymers in the thermoplastic resin component, as well as with the rubber component and additives. In a preferred aspect, the propylene-derived crystallinity is selected relative to any polypropylene resin present in the thermoplastic resin component. In some embodiments, the tacticity of the propylene-based copolymer and the tacticity of the thermoplastic resin component (which may include two or more different polypropylene polymers) may be the same or substantially the same. By “substantially” it is meant that these two components have at least 80% of the same tacticity. In another embodiment, the components have at least 90% of the same tacticity. In still another embodiment, the components have at least 100% of the same tacticity. Even if the components are of mixed tacticity, e.g., being partially isotactic and partially syndiotactic, the percentages in each should be at least about 80% the same as the other component in at least one or more embodiments.

In another embodiment, the propylene-based copolymers can include copolymers prepared according to the procedures in U.S. Pat. No. 6,884,850. Likewise, the propylene-based copolymer can include polymers consistent with those described in U.S. Pat. Nos. 6,960,635; 6,919,407; 6,927,256; 6,960,635; 6,943,215; and/or 6,906,160. Additionally, the propylene-based copolymer can include polymers consistent with those described in EP 1 233 191, and U.S. Pat. No. 6,525,157, along with suitable propylene homo- and copolymers described in U.S. Pat. No. 6,770,713 and U.S. Patent Application Publication 2005/215964. The propylene-based copolymer can also include one or more polymers consistent with those described in EP 1 614 699 or EP 1 017 729.

Illustrative propylene-based copolymers are commercially available from ExxonMobil Chemical under the tradename VISTAMAXX and from The Dow Chemical Company under the tradename VERSIFY.

### Additive Oil

The term “additive oil” includes both “process oils” and “extender oils.” The “additive oil” may include hydrocarbon oils and plasticizers, such as organic esters and synthetic plasticizers. Many additive oils are derived from petroleum fractions, and have particular ASTM designations depending on whether they fall into the class of paraffinic, naphthenic, or aromatic oils. Other types of additive oils include alpha olefinic synthetic oils, such as liquid polybutylene, e.g., products sold under the trademark PARAPOL (ExxonMobil Chemical Company). Additive oils other than petroleum based oils can also be used, such as oils derived from coal tar and pine tar, as well as synthetic oils, e.g., polyolefin materials (e.g., SPECTRASYN, ExxonMobil Chemical Company). Certain rubber components (e.g., EPDMs, such as VISTALON 3666, ExxonMobil Chemical Company) include additive oil that is preblended before the rubber component is combined with the thermoplastic. The type of additive oil utilized will be that customarily used in conjunction with a particular rubber component.

The ordinarily skilled chemist will recognize which type of oil should be used with a particular rubber, and also be able to determine the amount (quantity) of oil. The additive oil can be present in amounts from about 5 to about 300 parts by weight per 100 parts by weight of the blend of the rubber and isotactic polypropylene components. The amount of additive oil may also be expressed as from about 30 to 250 parts, and more desirably from about 70 to 200 parts by weight per 100 parts by weight of the rubber component. Alternatively, the quantity of additive oil can be based on the total rubber content, and defined as the ratio, by weight, of additive oil to total rubber and that amount may in certain cases be the combined amount of process oil (typically added during manufacturing of TPV before and/or after curing the rubber) and extender oil (typically added in the rubber during its manufacturing). The ratio may range, for example, from about 0 to about 4.0/1. Other ranges, having any of the following lower and upper limits, may also be utilized: a lower limit of 0.1/1, or 0.6/1, or 0.8/1, or 1.0/1, or 1.2/1, or 1.5/1, or 1.8/1, or 2.0/1, or 2.5/1; and an upper limit (which may be combined with any of the foregoing lower limits) of 4.0/1, or 3.8/1, or 3.5/1, or 3.2/1, or 3.0/1, or 2.8/1. Larger amounts of additive oil can be used, although the deficit is often reduced physical strength of the composition, or oil weeping, or both.

### Rubber Curing Agent

The rubber curing agent can be any curative that is capable of curing or crosslinking the rubber component may be used. Depending on the rubber employed, certain curatives may be preferred. Illustrative curatives include, but are not limited to, phenolic resins, peroxides, maleimides, sulfur containing curatives, and silicon-containing curatives. Illustrative phenolic resins are described in U.S. Pat. Nos. 2,972,600; 3,287,440; 4,311,628; and 6,433,090. A preferred phenolic resin curative is an octylphenol-formaldehyde resin sold commercially as SP-1045 from Schenectady International, Inc. Illustrative peroxide curatives are disclosed in U.S. Pat. No. 5,656,693. Useful silicon-containing curatives include silicon hydride compounds having at least two SiH groups. Illustrative silicon hydride compounds include, but are not limited to, methylhydrogen polysiloxanes, methylhydrogen dimethyl-siloxane copolymers, alkyl methyl polysiloxanes, bis(dimethylsilyl)alkanes, bis(dimethylsilyl)benzene, and mixtures thereof.

### COF Modifier

The COF modifier can be or include one or more siloxane polymers, fatty acids, fatty acid triglycerides, fatty acid amides, esters, fluoropolymers, graphite, molybdenum, silica, boron nitride, silicon carbide, or mixtures thereof. Illustrative siloxane polymers can include dialkyl polysiloxanes and silicone oils. Illustrative dialkyl polysiloxanes can include dimethyl polysiloxane, phenylmethyl polysiloxane, fluorinated polysiloxanes, tetramethyltetraphenyltrisiloxane and the hydroxy-functionalized polysiloxanes thereof. Preferred siloxane polymers include those having a weight average molecular weight of from about 200 to about 500,000 g/mole, preferably from about 10,000 to about 400,000 g/mole, and more preferably from about 100,000 to about 380,000 g/mole.

Illustrative fatty acids include those obtained from both animal and plant sources, and include both saturated and unsaturated acids. Illustrative saturated fatty acids can include butyric acid, lauric acid, palmitic acid, and stearic acid. Illustrative unsaturated fatty acids include oleic acid, linoleic acid, linolenic acid, and palymitoleic acid. Triglycerides of these fatty acids can also be used.

Illustrative fatty acid amides include lauramide, palmitamide, stearamide and behenamide; unsaturated fatty acid amides such as erucamide, oleamide, brassidamide and elaidamide; and bisfatty acid amides such as methylenebisstearamide, methylenebisoleamide, ethylenebisstearamide and ethylenebisoleamide.

Illustrative esters can include an ester of cetyl alcohol and acetic acid, an ester of cetyl alcohol and propionic acid, an ester of cetyl alcohol and butyric acid, an ester of beef tallow alcohol and acetic acid, an ester of beef tallow alcohol and propionic acid, an ester of beef tallow alcohol and butyric acid, an ester of stearyl alcohol and acetic acid, an ester of stearyl alcohol and propionic acid, an ester of stearyl alcohol and butyric acid, an ester of distearyl alcohol and phthalic acid, glycerol monooleate, glycerol monostearate, 12-hydroxylated stearates, glycerol tristearate, trimethylolpropane tristearate, pentaerythritol tetrastearate, butyl stearate, isobutyl stearate, stearic acid esters, oleic acid esters, behenic acid esters, calcium soap containing esters, isotridecyl stearate, cetyl palmitate, cetyl stearate, stearyl stearate, behenyl behenate, ethylene glycol montanate, glycerol montanate, pentaerythritol montanate and calcium containing montanic acid esters. Of these, an ester of distearyl alcohol and phthalic acid, glycerol monooleate, glycerol monostearate, stearic acid esters and glycerol montanate are preferred. Especially preferred is an ester of distearyl alcohol and phthalic acid, glycerol monostearate and glycerol montanate.

Illustrative fluoropolymers include polytetrafluoroethylene and vinylidene fluoride copolymers. In one embodiment, the COF modifier can be or include finely dispersed particles deriving from fluoropolymer powders. The size of these particles or powders is from about 0.1 microns to about 15 microns and preferably from about 0.2 microns to about 5.0 microns.

In at least one specific embodiment, the COF modifier can be or include a functionalized polyethylene copolymer. A preferred functionalized polyethylene copolymer is a low density polyethylene (LDPE) grafted copolymer manufactured by reactive compounding of a LDPE-copolymer containing a functional co-monomer and a silicone oil containing a silanol end group. The co-monomer in the LDPE copolymer is preferably vinyltrimethoxysilane. The silicone content can range from about 3 wt % to about 15 wt %, preferably from 4 wt % to 12 wt %, most preferably from 6 wt % to 10 wt %. A preferred functionalized polyethylene copolymer is LUBOTENE RLF, which is commercially available from Optatech Corporation.

In at least one embodiment above or elsewhere herein, the COF modifier can be or include mica. A preferred mica can be or include a phyllosilicate mineral of aluminum and potassium having a lamellar structure. Another preferred mica can be or include a Muscovite type with formula KAl₂ (AlSi₃O₁₀)(F, OH)₂ supplied by Alroko. The size of these particles or powders can be from about 0.1 microns to about 15 microns and preferably from about 0.2 microns to about 5.0 microns.

### Other Additives

The term “other additives” refers to, but is not limited to, particulate fillers, lubricants, antioxidants, antiblocking agents, stabilizers, anti-degradants, anti-static agents, waxes, foaming agents, pigments, flame retardants, processing aids, adhesives, tackifiers, plasticizers, wax, and discontinuous fibers (such as world cellulose fibers). Illustrative particulate fillers include carbon black, silica, titanium dioxide, calcium carbonate, colored pigments, clay, and combinations thereof. When non-black fillers are used, it may be desirable to include a coupling agent to compatibilize the interface between the non-black fillers and polymers. Desirable amounts of other additives, when present, range from about 1 to about 500 parts by weight per 100 parts by weight of rubber. Preferably, desirable amounts of carbon black, or other colorants, when present, are from about 5 to about 250 parts by weight per 100 parts by weight of rubber.

### Process Description

Any process for making TPVs can be used. In one or more embodiments, the individual materials and components, such as the one or more rubber components, thermoplastic resin components, COF modifiers, additive oils, curatives, other additives, etc., can be blended by melt-mixing in any order in a mixer heated to above the melting temperature of the thermoplastic resin component. The one or more rubber components, thermoplastic resin components, and curing agents can be added to the heated mixer as individual feed streams, as a tumbled blend, or as a masterbatch. The one or more thermoplastic resin components can be added before cure or divided in any proportions between before cure and after cure. The additive oil, e.g. process oil, can be added during mastication before cure, after cure, or divided in any proportions between before cure and after cure.

Illustrative mixing equipment can include extruders with kneaders or mixing elements with one or more mixing tips or flights, extruders with one or more screws, and extruders of co or counter rotating type. Suitable mixing equipment also include BRABENDER mixers, BANBURY mixers, Buss mixers and kneaders, and Farrell Continuous mixers, for example. One or more of those mixing equipment, including extruders, can be used in series.

Preferably, the one or more curing agents are incorporated into the melt within a target range of melt temperature over a specified period of time (<120 seconds). The one or more curing agents can be added using any suitable technique, such as by injection as a solution in a compatible process oil, as a neat solid, as a neat melt, or as a masterbatch, for example.

One or more fillers or other additives including the one or more COF modifiers can be introduced to the melt either before, during, or after the cure. The additives, fillers or other compounds, which may interfere with the curing agents, should be added after curing reaches the desired level. Preferably, those additives are added to the melt as a slurry or paste in a compatible rubber process oil. Powder blends or masterbatches of these components can be prepared in a wax or polymer carrier to facilitate metering and mixing. The required mixing for discrete rubber phase morphology and properties can be developed through choice of screw design and screw speed. It is convenient to follow the progression of vulcanization (crosslinking) by monitoring melt temperature or mixing energy or mixing torque requirements during mixing. The mixing torque or mixing energy curve generally goes through a maximum after which the mixing can be continued to achieve the desirable cure level (state) and improve the fabricability for the blend. Following the cure and sufficient mixing of the melt, the melt blend can be processed to form an elastomeric structure using any one or more of the following techniques: milling, chopping, extrusion, pelletizing, injection molding, or any other desirable technique. Additional details for making TPV compositions are described in U.S. Pat. No. 4,594,390.

Preferably, the thermoplastic vulcanizate component contains a sufficient amount of each component, e.g. the at least one rubber component, COF modifier, and propylene-based copolymer to provide a structure or piece having a Shore D Hardness of 90 or less, 80 or less, 70 or less, 60 or less, 50 or less, 40 or less, 30 or less, or 20 or less. In one or more embodiments, the Shore D Hardness can range from a low of about 10, 15, or 20 to a high of about 40, 65, or 90.

In one or more embodiments, the thermoplastic vulcanizate component comprises of from 1 wt % to 50 wt % of the propylene-based copolymer based on total weight of the component. The thermoplastic vulcanizate component can include of from 5 wt % to 50 wt % of the propylene-based copolymer based on total weight of the component. The propylene-based copolymer can be also be present in an amount ranging from a low of about 1 wt %, 5 wt %, 10 wt %, or 15 wt % to a high of about 20 wt %, 25 wt %, 35 wt %, 40 wt %, or 49 wt % based on total weight of the component. In one or more embodiments, the propylene-based copolymer can be present in an amount of from about 1 wt % to 49 wt %, 44 wt %, 39 wt %, 34 wt %, 29 wt %, 24 wt %, or 19 wt %. In one or more embodiments, the propylene-based copolymer can be present in an amount of about 50 wt % or less, 45 wt % or less, 40 wt % or less, 35 wt % or less, 30 wt % or less, 25 wt % or less, 20 wt % or less, or 15 wt % or less.

In one or more embodiments, the thermoplastic vulcanizate component comprises of from 1 wt % to 85 wt % of the rubber component based on total weight of the component. The rubber component can be present in an amount ranging from a low of about 1 wt %, 5 wt %, 10 wt %, or 15 wt % to a high of about 55 wt %, 65 wt %, 75 wt %, 80 wt %, or 85 wt % based on total weight of the component. In one or more embodiments, the rubber component can be present in an amount of from about 5 wt % to 49 wt %, 59 wt %, 60 wt %, 79 wt %, 82 wt %, 84 wt %, or 85 wt %. In one or more embodiments, the rubber component can be present in an amount of about 85 wt % or less, 80 wt % or less, 75 wt % or less, 70 wt % or less, 65 wt % or less, 60 wt % or less, 55 wt % or less, or 45 wt % or less.

In one or more embodiments, the thermoplastic vulcanizate component comprises of from 0.1 wt % to 25 wt % of the COF modifier based on total weight of the component. The COF modifier can be present in an amount ranging from a low of about 0.1 wt %, 0.5 wt %, 1.0 wt %, or 2.0 wt % to a high of about 4.0 wt %, 5.0 wt %, 6.0 wt %, 8.0 wt %, or 10.0 wt % based on total weight of the component. In one or more embodiments, the COF modifier can be present in an amount of from about 1 wt % to 2 wt %, 3 wt %, 4 wt %, 5 wt %, 10 wt %, 15 wt %, or 19 wt %. In one or more embodiments, the COF modifier can be present in an amount of about 20 wt % or less, about 15 wt % or less, about 10 wt % or less, 9 wt % or less, 8 wt % or less, 7 wt % or less, 6 wt % or less, 4 wt % or less, 4 wt % or less, or 3 wt % or less.

### Articles

In one or more embodiments, a first piece or component that is or includes the thermoplastic elastomer can be at least partially adhered or otherwise attached to a second piece or component that is or includes a rubber component. Preferably, the second piece or component is or includes an EPDM thermoset based component that comprises one or more thermoset ethylene copolymer rubbers.

The two pieces can be at least partially adhered to one another by extrusion, injection molding, blow molding, or compression molding techniques to form a composite article or structure exhibiting excellent adhesion therebetween. Preferably, at least one end of the first piece is adhered to an end of the second piece such that the first piece and the second piece are adhered end to end, or butt-welded. In at least one specific embodiment, the first piece is a corner piece or corner section, and the second piece is a straight piece or straight section. In at least one specific embodiment, the first piece is a straight piece or straight section, and the second piece is a corner piece or corner section.

Preferably, the adhesion between the first piece and the second piece is about 3.0 MPa or more when measured at room temperature according to ISO-37. More preferably, the adhesion between the first piece and the second piece is about 3.2 MPa or more, 3.5 MPa or more, 3.8 MPa or more, 4.0 MPa or more, 4.4 MPa or more, 4.9 MPa or more, or 6.0 MPa or more, when measured at room temperature according to ISO-37.

Illustrative composite structures include, but are not limited to, vehicle parts, especially interior and exterior parts, for automobiles, airplanes, train cars, All Terrain Vehicles (ATVs), snowmobiles, boats, jet skis, motorcycles, and any other 2, 4 or more wheeled vehicles. Specific vehicle parts include, but are not limited to, exterior weather seals such as molded corners, molded end caps, glass run channels, trunk seals, tailgate seals, cowl seals, gap fillers, glass encapsulation, cut line seals, door seals, hood-to-radiator seals, windshield seals, sunroof seals, roof line seals, rear window seals, rocker panels, sashes, and belt-line seals, for example. Particularly contemplated is the fabrication of a glass run channel, door seal or belt line seal that may include coloring, low friction coating, thermoplastic veneer or thermoplastic overmolding. A particular belt-line seal is shown and described in U.S. Pat. No. 6,368,700.

Glass run channels typically have one type of rubber extruded in such form that the glass is guided during the rewinding operation and then ensures good insulation when the glass is closed. Movement in the channel is generally facilitated by a flock deposit inside the rubber channel. This flock is adhered to the rubber with a curable element, generally chloroprene based.

Door seals typically have three different rubber compounds. A microcellular profile is in contact with the car body frame that uses compression to provide adequate sealing against water, air, and aerodynamic noise. A metal carrier compound, generally rigidified by a flexible stamped metal co-extruded with the rubber, holds the sponge portion and is further gripped on the car body. Soft rubber lips inside the metal carrier provide a tight link between the rubber components and the metallic body frame of the car. Up to now, door seals have generally been manufactured using EPDM thermoset type rubber generally without any other material addition.

Inner and outer belt line seals generally have two coextruded parts: one flexible portion against the glass and modified as described above to facilitate the motion of the glass, and one stiff portion that is rigidified, generally with a metal, steel or aluminum coextruded with the rubber compound.

The resulting sealing systems have combinations of properties rendering them superior and unique to profiles previously available for vehicles. Vehicles contemplated include, but are not limited to passenger autos, trucks of all sizes, farm vehicles, trains, and the like. Such elastomeric profiles can also be used in other applications than automotive, like railway cars, building and construction.

For purposes of convenience, various specific test procedures are identified for determining properties such as mechanical, adhesion, and COF. However, when a person of ordinary skill reads this patent and wishes to determine whether a composition or polymer has a particular property identified in a claim, then any published or well-recognized method or test procedure can be followed to determine that property, although the specifically identified procedure is preferred. Such test procedures that refer to a “room temperature,” unless otherwise defined, is intended to mean 23° C. plus or minus 2° C. In the claims, each claim should be construed to cover the results of any of such procedures, even to the extent different procedures may yield different results or measurements. Thus, a person of ordinary skill in the art is to expect experimental variations in measured properties that are reflected in the claims. All numerical values can be considered to be “about” or “approximately” the stated value, in view of the nature of testing in general.

### Examples

The following non-limiting examples illustrate the surprising adhesion between a thermoplastic vulcanizate and thermoset rubber, and resulting composite structures having a surprisingly low coefficient of friction (COF). More particularly, the following thermoplastic vulcanizate samples that included the COF modifier and propylene-based copolymer showed a surprising increase in adhesion to an EPDM thermoset substrate compared to a similar thermoplastic vulcanizate sample that did not contain the COF modifier.

The formulation of the EPDM thermoset rubber composition is shown in Table 1. Four thermoplastic vulcanizate (TPV) compositions according to one or more embodiments described herein (Examples, 1-4) and four comparative thermoplastic vulcanizate (TPV) compositions (Comparative Examples, C₁-C₄) were prepared according to the formulations shown in Table 2.

TABLE 1
Formulation of EPDM Thermoset Rubber Composition.

| Component | phr |
|---|---|
| VISTALON 9500 | 100 |
| EP(ENB)M rubber (ExxonMobil Chemical Company) | |
| FEF N 550 | 130 |
| carbon black (Cabot Plastic) | |
| FLEXON 815 | 80 |
| process oil (ExxonMobil Chemical Company) | |
| KODAK 911 | 5 |
| zinc oxide (Zinc Corporation of America) | |
| Stearic Acid | 1 |
| Calcium Oxide (80%) | 5 |
| (80% Calcium Oxide, 20% oil) | |
| Sulfur | 1.5 |
| DPG | 0.3 |
| (N,N-di-phenylguanidine) | |
| MBT (75%) | 0.5 |
| (75% 2-mercaptobenzothiazol, 25% oil) | |
| MBTS (80%) | 0.3 |
| (80% 2,2-benzothiazyl disulfide, 20% oil) | |
| ZDBC (80%) | 1.3 |
| (80% Zinc dibutyldithiocarbamate, 20% oil) | |
| VULKALENT E/C | 0.2 |
| (Lanxess Corporation) | |

VISTALON 9500 is an ethylene, propylene, 5-ethylidene-2-norbornene copolymer with an ethylene content of 60 wt % and ENB content of 11 wt %, and a Mooney viscosity [ML(1+4)@ 125° C.]=72.

VULKALENT E/C is a sulphonamide derivative cross-linking regulator.

TABLE 2
Formulations (wt %) Of The Thermoplastic Vulcanizate Compositions

| | EXAMPLES | | | | | | | |
|---|---|---|---|---|---|---|---|---|
| | 1 | 2 | 3 | 4 | C1 | C2 | C3 | C4 |
| S121-62M100 | 62 | 62 | | | | 67 | | |
| (ExxonMobil Chemical | | | | | | | | |
| Company) | | | | | | | | |
| PCP-01 | 14 | 14 | 14 | 14 | | 14 | 14 | 14 |
| PP ADSYL 5 C30 F | 14 | 14 | 14 | 14 | | 14 | 14 | 14 |
| (LyondellBasell) | | | | | | | | |
| PP 4045 | 5 | 5 | 6 | 6 | | 5 | 6 | 6 |
| (Cabot Plastic) | | | | | | | | |
| LUBOTENE RLF 4006 | 5 | | | | | | | |
| (Optatech Corp.) | | | | | | | | |
| LUBOTENE RLF 4009 | | 5 | 5 | | | | | |
| (Optatech Corp.) | | | | | | | | |
| Mica 325 Mesh | | | | 6 | | | | |
| S121-79W233 | | | | | 100 | | | |
| (ExxonMobil Chemical | | | | | | | | |
| Company) | | | | | | | | |
| V3666 | | | 30.44 | 30.44 | | | 30.44 | 32.89 |
| (ExxonMobil Chemical | | | | | | | | |
| Company) | | | | | | | | |
| ICECAP K clay | | | 4.72 | 3.72 | | | 4.72 | 5.26 |
| (Burgess Pigment | | | | | | | | |
| Company) | | | | | | | | |
| ZnO | | | 0.5 | 0.5 | | | 0.5 | 0.5 |
| SnCl₂ | | | 0.3 | 0.3 | | | 0.3 | 0.3 |
| (Sigman-Aldrich Corp.) | | | | | | | | |
| PP BC245MO | | | 9 | 9 | | | 9 | 9.7 |
| (Borealis AG) | | | | | | | | |
| SP1045 | | | 1 | 1 | | | 1 | 1 |
| (SI Group, Inc.) | | | | | | | | |
| Plastol 537 | | | 15.04 | 15.04 | | | 15.04 | 16.35 |
| (ExxonMobil Chemical | | | | | | | | |
| Company) | | | | | | | | |
| MB50-002 | | | | | | | 5 | |
| (Dow Corning Corp.) | | | | | | | | |

S121-62M100 is a PP/EPDM based thermoplastic vulcanizate.
PCP-01, the propylene-based copolymer, is a metallocene catalyzed polypropylene/polyethylene random copolymer having 11% by total weight of ethylene. This propylene-based copolymer had a Mooney viscosity of 7 (according to ASTM D 1646 at 230° C., 2.16 kg), and a melting point of less than 100° C.
PP ADSYL 5C30F is a propylene/ethylene/butene random copolymer with a MFR of 5.5 (according to ASTM D-1238 at 230° C., 2.16 kg).
PP 4045 is a carbon black master batch in polypropylene with 40 weight % carbon black.
LUBOTENE RLF 4006 and RLF 4009 are COF modifiers.
Mica 325 Mesh is a mica with an average particle size of 325 mesh and supplied by Alroko.
S121-79W233 is a PP/EPDM based thermoplastic vulcanizate.
V3666 is an ethylene, propylene, 5-ethylidene-2-norbornene copolymer with an ethylene content of 64 wt % and ENB content of 4.5 wt %, extender oil of 75 phr and Mooney viscosity [ML(1 + 4)@ 125° C.] of 50.
ICECAP K clay is a calcined clay.
SnCl₂ is the catalyst for rubber vulcanization.
PP BC245MO is a propylene ethylene reactor copolymer with a MFR of 3.5 (according to ASTM D-1238 at 230° C., 2.16 kg).
SP 1045 is a phenolic resin curing agent.
PLASTOL 537 is a paraffinic process oil.
MB50-002 is a high molecular weight silicone rubber master batch with 50 weight % silicone rubber.

Each example was prepared in a 1.3 liter BANBURY mixer according to the formulations shown in Table 2. The rubber components, thermoplastic resins including the propylene-based copolymer, a carbon black masterbatch, mineral filler, ZnO, SnCl₂, and the COF modifier were added to the mixer at a temperature of 200° C. and mixed for 3 minutes at 170 rpm, then ⅓ of free processing oil was added and continued to mix two minutes more, then the second ⅓ of free processing oil was added and continued to mix two more minutes before adding the phenolic resin curing agent and mixed 3 more minutes keeping the temperature between 180° C. to 210° C. Then, the last ⅓ of free processing oil was added and continued to mix for 2 more minutes before dumping the melt.

A sheet was made out of the TPV melt on a calendar followed by granulation. The granulates were injection molded to produce plaques of 150 mm long, 100 mm wide, and 2 mm thick. The mechanical properties were tested on the injection molded plaques of 150 mm long, 100 mm wide and 2 mm thick either perpendicular or parallel or both to flow directions according the norms indicated in Table 4.

The COF of the TPV was measured according to ASTM D1894 against glass with injection molded plaques of 63.5 mm long, 63.5 mm wide, and 2 mm thick.

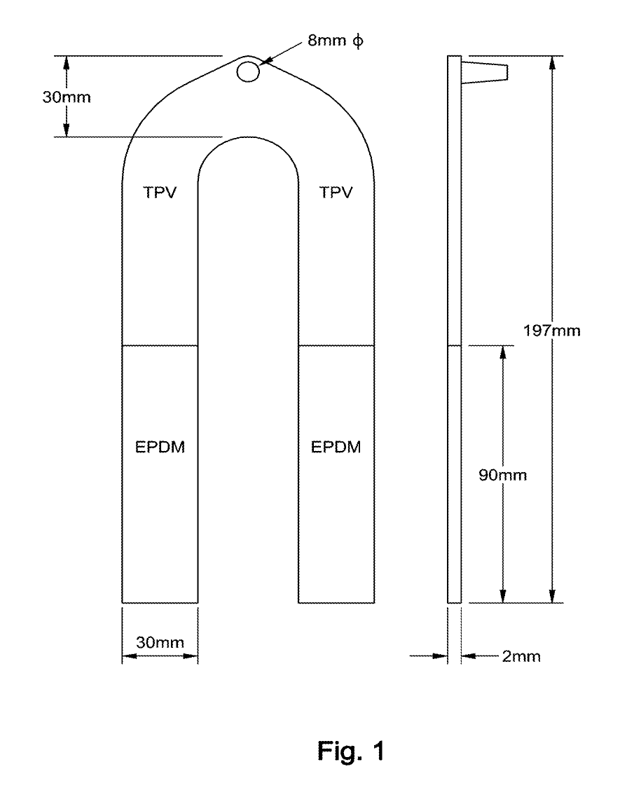

Adhesion between the TPV and the EPDM thermoset rubber was measured using a pre-cut sample of the EPDM thermoset rubber. The pre-cut sample had an “U shape” as illustrated in FIG. 1. To prepare the pre-cut sample, the EPDM thermoset rubber was fully cured and compounded in a tangential type internal mixer (BANBURY 16 L mixer). A masterbatch was mixed in a first pass and then finalized with the addition of the curatives in the second pass. The EPDM thermoset rubber composition was hot air cured at 230° C. and then extruded. The EPDM thermoset rubber composition was extruded at a line speed of 3 m/min into a flat strip (45 mm wide and 2 mm thick) at 100° C. to form the EPDM thermoset rubber structure. Pads 90 mm long and 30 mm wide were freshly cut and inserted into the U shape (FIG. 1) mold. The molten thermoplastic vulcanizate composition was then injected into the mold to adhere to the EPDM thermoset rubber structure to form a composite structure.

The adhesion between the thermoplastic elastomer vulcanizate and the EPDM thermoset rubber was then tested. The adhesion testing of the composite structure was performed by cutting a series of dumbbells ISO Type S2 from the interface of the dumbbells prepared above, of which the top half was the thermoplastic vulcanizate structure and the bottom half was the EPDM thermoset rubber structure. The dumbbells were conditioned for 24 hours at the specified test temperature. Table 3 illustrates the injection molding conditions for the preparation of the specimens for the adhesion testing.

TABLE 3
Injection Molding Conditions For Adhesion Testing.

| Injection molding temperature profile | 200-230-260-260° C. | |
|---|---|---|
| Mold temperature | 40° | C. |
| Injection molding speed | 150 | mm/sec. |
| Post injection molding pressure | 20 | bar |
| Post injection time | 10 | sec. |
| Cooling time | 30 | sec. |

The adhesion level was measured according to ISO 37. Specifically, the adhesion level was measured by pulling the ends of the dumbbell samples in a tensometer at the specified test conditions at a speed of 100 mm per minute, and the failure type was noted. The notation “cohesive” means that the failure occurred in the body of either the EPDM thermoset rubber or the thermoplastic vulcanizate. The notation “adhesion” means that the failure occurred at the interface between the EPDM thermoset rubber and the thermoplastic vulcanizate. Table 4 summarizes the results of the testing.

TABLE 4
Test Results

| | | EXAMPLES | | | | | | | |
|---|---|---|---|---|---|---|---|---|---|
| PROPERTIES | PROCEDURE | 1 | 2 | 3 | 4 | C1 | C2 | C3 | C4 |
| Hardness | ISO 868; 15 s delay | 88 | 87 | 86 | 85 | 84 | 86 | 84 | 85 |
| Adhesion strength on EDPM at RT- 100 mm/min | | | | | | | | | |
| Tensile Strength, MPa | ISO 37 | 5.9 | 6.8 | 6.3 | 5.9 | 4.5 | 5.4 | 5.2 | 5.6 |
| Elongation at Break, % | ISO 37 | 223 | 257 | 274 | 208 | 206 | 203 | 175 | 198 |
| Modulus @ 100% Strain, MPa | ISO 37 | 4.3 | 4.4 | 4.5 | 4.8 | 3.7 | 4.1 | 4.4 | 4.4 |
| Failure type | ISO 37 | cohesive | cohesive | cohesive | cohesive | adhesive | cohesive | cohesive | cohesive |
| Adhesion strength on EDPM at 70° C.- 100 mm/min | | | | | | | | | |
| Tensile Strength, MPa | ISO 37 | 1.9 | 3.1 | 3.2 | 2.3 | 1.6 | 1.9 | 1.9 | 2.1 |
| Elongation at Break, % | ISO 37 | 97 | 184 | 178 | 143 | 62 | 67 | 88 | 68 |
| Modulus @ 100% Strain, MPa | ISO 37 | | 3.2 | 2.6 | 1.8 | — | | | |
| Failure type | ISO 37 | adhesive | cohesive | cohesive | cohesive | adhesive | adhesive | adhesive | adhesive |
| Coefficient of friction on Glass (COF)- 250 mm/min; | | | | | | | | | |
| 1000 g load | | | | | | | | | |
| Static COF | Polished sample | 0.71 | 0.45 | 0.46 | 0.49 | 1.04 | 0.87 | 1.35 | 0.82 |
| Kinetic COF | Polished sample | 0.54 | 0.42 | 0.44 | 0.51 | 1.15 | 0.77 | 1.42 | 0.79 |
| Static COF | Unpolished sample | 0.45 | 0.42 | 0.41 | 0.39 | 1.03 | 0.74 | 1.11 | 0.73 |
| Kinetic COF | Unpolished sample | 0.37 | 0.27 | 0.28 | 0.41 | 1.01 | 0.58 | 1.13 | 0.42 |
| Physical Properties at RT (perpendicular/parallel) | | | | | | | | | |
| Tensile Strength, MPa | ISO 37 | 12.1/9.9 | 11.9/9.6 | 11.4/9.8 | 10.8/9.2 | 7.4/6.9 | 14.5/12.1 | 11.1/9.7 | 13.9/12.0 |
| Elongation at Break, % | ISO 37 | 689/587 | 692/592 | 654/521 | 674/578 | 620/553 | 737/652 | 708/543 | 728/599 |
| Modulus @ 100% Strain, MPa | ISO 37 | 5.1/5.3 | 5.0/5.3 | 5.1/5.4 | 5.0/5.2 | 3.6/4.2 | 4.6/4.9 | 5.2/5.6 | 4.7/5.1 |
| Tear Strength | ISO 34-Ba; angle/ | 37/36 | 36/36 | 35/36 | 37/37 | 36/36 | 38/39 | 36/36 | 37/37 |
| | no nick | | | | | | | | |
| Compression set | | | | | | | | | |
| 25% Compression, 22 hrs/RT | ISO 815-91- Type B | 22 | 16 | 16 | Not tested | 21 | 19 | Not tested | 20 |
| 25% Compression, 22 hrs/70° C. | ISO 815-91- Type B | 50 | 49 | 47 | Not tested | 49 | 42 | Not tested | 41 |

As shown in Table 4, a surprising adhesion was observed between the thermoplastic vulcanizate and the thermoset rubber. More particularly, those thermoplastic vulcanizate samples containing the COF modifier and propylene-based copolymer (examples 1-4) showed a surprising increase in adhesion to an EPDM thermoset rubber substrate compared to similar thermoplastic vulcanizate samples that did not contain the COF modifier (comparative examples, C1-C4). In some cases, the increase in adhesion was more than 50%. It is also noteworthy that none of the inventive examples (1-4) exhibited adhesive failure at 70° C.

A low coefficient of friction (COF) was also obtained. In some cases, the COF was reduced by more than half in the polished samples and reduced by more than two-thirds in the unpolished samples. Undoubtedly, the inventive examples (1-4) showed an unexpected and significant improvement in coefficient of friction.

Other embodiments include:

1. A composite structure, comprising: a first piece comprising: a thermoplastic vulcanizate component that includes an at least partially crosslinked rubber, a COF modifier, and a propylene-based copolymer that has (i) 60 wt % or more units derived from propylene, (ii) isotactically arranged propylene derived sequences and (iii) a heat of fusion less than 45 J/g, and a second piece at least partially adhered to the first piece, the second piece comprising an EPDM thermoset based component that comprises one or more thermoset ethylene copolymer rubbers.
2. The composite structure according to numbered paragraph 1, wherein the thermoplastic vulcanizate component comprises from 1 wt % to 50 wt % of the propylene-based copolymer based on total weight of the first piece.
3. The composite structure according to numbered paragraphs 1 or 2, wherein the thermoplastic vulcanizate component comprises of from 10 wt % to 40 wt % of the propylene-based copolymer based on total weight of the first piece.
4. The composite structure according to any one or more of numbered paragraphs 1 to 3, wherein the thermoplastic vulcanizate component comprises of from 5 wt % to 85 wt % of the at least partially crosslinked rubber based on total weight of the first piece.
5. The composite structure according to any one or more of numbered paragraphs 1 to 4, wherein the at least partially crosslinked rubber is EPDM.
6. The composite structure according to any one or more of numbered paragraphs 1 to 5, wherein the at least partially crosslinked rubber is EPR.
7. The composite structure according to any one or more of numbered paragraphs 1 to 6, wherein the propylene-based copolymer is a propylene/ethylene copolymer having an ethylene content of greater than 8 wt % and up to about 30 wt % based on total weight of the propylene-based copolymer.
8. The composite structure according to any one or more of numbered paragraphs 1 to 7, wherein the propylene-based copolymer is a propylene/ethylene copolymer having an ethylene content of from about 10 wt % to about 15 wt % based on total weight of the propylene-based copolymer.
9. The composite structure according to any one or more of numbered paragraphs 1 to 8, wherein the first piece has a Shore D Hardness of 30 or less.
10. The composite structure according to any one or more of numbered paragraphs 1 to 9, wherein the first piece has a Shore A hardness of less than 90 and the adhesion between the first piece and the second piece is about 3.0 MPa or more.
11. The composite structure according to any one or more of numbered paragraphs 1 to 10, wherein the adhesion between the first piece and the second piece is about 3.2 MPa or more, when measured at room temperature according to ISO-37.
12. The composite structure according to any one or more of numbered paragraphs 1 to 11, wherein: the first piece further comprises at least partially crosslinked EPDM, random polypropylene and 5 wt % or more of the propylene-based copolymer based on total weight of the first piece; and the adhesion between the first piece and the second piece is about 3.2 MPa or more, when measured at room temperature according to ISO-37.
13. A composite structure, comprising: a first piece comprising: a thermoplastic vulcanizate component that includes an at least partially crosslinked EPDM rubber, a COF modifier, and 5 wt % or more propylene-based copolymer comprising (i) 60 wt % or more units derived from propylene, (ii) isotactically arranged propylene derived sequences and (iii) a heat of fusion less than 45 J/g; and a second piece at least partially adhered to the first piece, the second piece comprising an EPDM thermoset based component comprising one or more thermoset ethylene copolymer rubbers, wherein the adhesion between the first piece and the second piece is about 3.2 MPa or more when measured at room temperature according to ISO-37.
14. The composite structure according to numbered paragraph 13, wherein the thermoplastic vulcanizate component comprises from 1 wt % to 50 wt % of the propylene-based copolymer based on total weight of the first piece.
15. The composite structure according to numbered paragraphs 13 or 14, wherein the thermoplastic vulcanizate component comprises of from 10 wt % to 40 wt % of the propylene-based copolymer based on total weight of the first piece.
16. The composite structure according to any one or more of numbered paragraphs 13 to 15, wherein the thermoplastic vulcanizate component comprises of from 5 wt % to 85 wt % of the at least partially crosslinked rubber based on total weight of the first piece.
17. The composite structure according to any one or more of numbered paragraphs 13 to 16, wherein the at least partially crosslinked rubber is EPDM.
18. The composite structure according to any one or more of numbered paragraphs 13 to 17, wherein the first piece is a corner piece and the second piece is a straight piece.
19. The composite structure according to any one or more of numbered paragraphs 13 to 18, wherein the propylene-based copolymer is a propylene/ethylene copolymer having an ethylene content of greater than 8 wt % and up to about 30 wt % based on total weight of the propylene-based copolymer.
20. The composite structure according to any one or more of numbered paragraphs 13 to 19, wherein the propylene-based copolymer is a propylene/ethylene copolymer having an ethylene content of from about 10 wt % to about 15 wt % based on total weight of the propylene-based copolymer, and wherein the first piece has a Shore A hardness of less than 90.
21. The composite structure according to any one or more of numbered paragraphs 13 to 20, wherein the first piece and the second piece form at least a portion of a glass run channel, door seal or belt line seal for an automobile.
22. A method for making a composite structure, comprising: injection molding a first composition and a second composition to form the composite structure, the first composition comprising: a thermoplastic vulcanizate component that includes an at least partially crosslinked rubber, a COF modifier, and a propylene-based copolymer that has (i) 60 wt % or more units derived from propylene, (ii) isotactically arranged propylene derived sequences and (iii) a heat of fusion less than 45 J/g; and the second piece comprising an EPDM thermoset based component that comprises one or more thermoset ethylene copolymer rubbers.
23. The method according to numbered paragraph 22, wherein the propylene-based copolymer is a propylene/ethylene copolymer having an ethylene content of from about 10 wt % to about 15 wt % based on total weight of the propylene-based copolymer.
24. The method according to numbered paragraphs 22 or 23, wherein the thermoplastic vulcanizate component comprises of from 10 wt % to 50 wt % of the at least partially crosslinked rubber, based on total weight of the component.
25. The method according to any one or more of numbered paragraphs 22 to 24, wherein the thermoplastic vulcanizate component comprises of from 5 wt % to 50 wt % of the propylene-based copolymer, based on total weight of the component.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A composite structure, comprising:
a first piece comprising: a thermoplastic vulcanizate component that includes an at least partially crosslinked rubber, a COF modifier, and a propylene-based copolymer that has (i) 60 wt % or more units derived from propylene, (ii) isotactically arranged propylene derived sequences and (iii) a heat of fusion less than 45 J/g, and
a second piece at least partially adhered to the first piece, the second piece comprising an EPDM thermoset based component that comprises one or more thermoset ethylene copolymer rubbers.

2. The composite structure of claim 1, wherein the thermoplastic vulcanizate component comprises from 1 wt % to 50 wt % of the propylene-based copolymer based on total weight of the first piece.

3. The composite structure of claim 1, wherein the thermoplastic vulcanizate component comprises of from 10 wt % to 40 wt % of the propylene-based copolymer based on total weight of the first piece.

4. The composite structure of claim 1, wherein the thermoplastic vulcanizate component comprises of from 5 wt % to 85 wt % of the at least partially crosslinked rubber based on total weight of the first piece.

5. The composite structure of claim 1, wherein the at least partially crosslinked rubber is EPDM.

6. The composite structure of claim 1, wherein the at least partially crosslinked rubber is EPR.

7. The composite structure of claim 1, wherein the propylene-based copolymer is a propylene/ethylene copolymer having an ethylene content of greater than 8 wt % and up to about 30 wt % based on total weight of the propylene-based copolymer.

8. The composite structure of claim 1, wherein the propylene-based copolymer is a propylene/ethylene copolymer having an ethylene content of from about 10 wt % to about 15 wt % based on total weight of the propylene-based copolymer.

9. The composite structure of claim 1, wherein the first piece has a Shore D Hardness of 30 or less.

10. The composite structure of claim 1, wherein the first piece has a Shore A hardness of less than 90 and the adhesion between the first piece and the second piece is about 3.0 MPa or more.

11. The composite structure of claim 1, wherein the adhesion between the first piece and the second piece is about 3.2 MPa or more, when measured at room temperature according to ISO-37.

12. The composite structure of claim 1, wherein:
the first piece further comprises at least partially crosslinked EPDM, random polypropylene and 5 wt % or more of the propylene-based copolymer based on total weight of the first piece; and
the adhesion between the first piece and the second piece is about 3.2 MPa or more, when measured at room temperature according to ISO-37.

13. A composite structure, comprising:
a first piece comprising: a thermoplastic vulcanizate component that includes an at least partially crosslinked EPDM rubber, a COF modifier, and 5 wt % or more propylene-based copolymer comprising (i) 60 wt % or more units derived from propylene, (ii) isotactically arranged propylene derived sequences and (iii) a heat of fusion less than 45 J/g; and
a second piece at least partially adhered to the first piece, the second piece comprising an EPDM thermoset based component comprising one or more thermoset ethylene copolymer rubbers, wherein the adhesion between the first piece and the second piece is about 3.2 MPa or more when measured at room temperature according to ISO-37.

14. The composite structure of claim 13, wherein the thermoplastic vulcanizate component comprises from 1 wt % to 50 wt % of the propylene-based copolymer based on total weight of the first piece.

15. The composite structure of claim 13, wherein the thermoplastic vulcanizate component comprises of from 10 wt % to 40 wt % of the propylene-based copolymer based on total weight of the first piece.

16. The composite structure of claim 13, wherein the thermoplastic vulcanizate component comprises of from 5 wt % to 85 wt % of the at least partially crosslinked rubber based on total weight of the first piece.

17. The composite structure of claim 13, wherein the at least partially crosslinked rubber is EPDM.

18. The composite structure of claim 13, wherein the first piece is a corner piece and the second piece is a straight piece.

19. The composite structure of claim 13, wherein the propylene-based copolymer is a propylene/ethylene copolymer having an ethylene content of greater than 8 wt % and up to about 30 wt % based on total weight of the propylene-based copolymer.

20. The composite structure of claim 13, wherein the propylene-based copolymer is a propylene/ethylene copolymer having an ethylene content of from about 10 wt % to about 15 wt % based on total weight of the propylene-based copolymer, and wherein the first piece has a Shore A hardness of less than 90.

21. The composite structure of claim 13, wherein the first piece and the second piece form at least a portion of a glass run channel, door seal or belt line seal for an automobile.

22. A method for making a composite structure, comprising:
injection molding a first composition and a second composition to form the composite structure, the first composition comprising:
a thermoplastic vulcanizate component that includes an at least partially crosslinked rubber, a COF modifier, and a propylene-based copolymer that has (i) 60 wt % or more units derived from propylene, (ii) isotactically arranged propylene derived sequences and (iii) a heat of fusion less than 45 J/g; and
the second piece comprising an EPDM thermoset based component that comprises one or more thermoset ethylene copolymer rubbers.

23. The method of claim 22, wherein the propylene-based copolymer is a propylene/ethylene copolymer having an ethylene content of from about 10 wt % to about 15 wt % based on total weight of the propylene-based copolymer.

24. The method of claim 22, wherein the thermoplastic vulcanizate component comprises of from 10 wt % to 50 wt % of the at least partially crosslinked rubber, based on total weight of the component.

25. The method of claim 22, wherein the thermoplastic vulcanizate component comprises of from 5 wt % to 50 wt % of the propylene-based copolymer, based on total weight of the component.
